(19) United States
(12) Patent Application Publication
(10) Pub. No.: US 2005/0244626 A1
(43) Pub. Date: Nov. 3, 2005

(54) Multilayer polyurea insulated roofing system

(76) Inventor: David Leslie, Allen, TX (US)

Correspondence Address: Patent Administrator;KATTEN MUCHIN ZAVIS ROSENMAN, Suite 1600, 525 West Monroe Street, Chicago, IL, 60661, US

(21) Appl. No.: 10/836,294

(22) Filed: Apr. 30, 2004

(51) Int. Cl. B32B 3/26; B32B 3/00; B32B 7/12; B05D 3/00; G21H 5/00; E04B 5/00; C08J 7/18

(52) U.S. Cl. 428/304.4; 428/316.6; 428/317.1; 427/553

(57) ABSTRACT

The present invention relates to a multilayer polyurea roofing system. An important aspect of the invention is the use of multilayers of polyurea with the base layer having a minimum thickness of 40 mils, thus forming a waterproofing membrane. The multiple layers of polyurea provide increased structural strength, as well as reduce failures caused by applicator error. Moreover, in applications where the polyurethane is applied to insulation board stock, the polyurea membrane is isolated from movements between the base insulation and the roof deck (i.e., wood, metal, concrete decking).

### BACKGROUND OF THE INVENTION

1. Field of the Invention

The present invention relates to a roofing system and more particularly to a multilayer polyurea roofing system which includes a polyurethane substrate which also provides thermal insulation and two or more layers of polyurea which form a structural waterproofing membrane in which the base layer of polyurea has a minimum thickness of 40 mils.

2. Description of the Prior Art

Roofing systems for use in low slope or flat roofs are known. Examples of such roofing systems are disclosed in “The Manual of Low Slope Roof Systems,” Third Edition by C. W. Griffin and Richard Fricklas, McGraw Hill, copyright 1996, hereby incorporated by reference. All known roofing systems including low slope and flat roofing systems are known to include at least three basic components: a substrate, thermal insulation and a water-proofing membrane. Four primary types of roofing systems are known: Built-up roof (asphalt or cold tarp pitch base), modified bitumen (asphalt based premanufactured sheets), single ply (EPDM, TPO and PVC) and spray foam polyurethane (polyurethane foam with silicone, acrylic, polyurethane and polyurea coatings). Built-up roof and modified bitumen roofing systems are known to use two layers of insulation board stock as the substrate for the roof membrane. The first layer is used for insulation and to provide a flat surface. The second layer is used to provide increased insulation and to isolate the roof membrane from the wear/fatigue factor created by the fasteners and insulation board transitions. Sprayed polyurethane foam roofing systems utilize polyurethane as both a substrate and as insulation. In such sprayed polyurethane roofing systems, the polyurethane foam is normally applied at a thickness of one inch or greater and thus provides the primary waterproofing protecting for the roof. Because of the vulnerability of the polyurethane foam to ultraviolet light and impact damage, a coating of polyurea is normally applied at a thickness of less than 40 mil. In such an application and thickness, the polyurea simply protects the polyurethane foam from ultraviolet light deterioration and impact damage. In addition to polyurea, acrylic, silicone and polyurethane coatings are also known to be used. The sprayed polyurethane roofing systems are also known to be applied directly to roof decks, such as wood, metal or concrete decks or applied on top of existing roofing systems, such as built up roof, tar and gravel, modified bitumen and metal roofs.

As mentioned above, single ply roofing systems are also known. An example of a single ply roofing system is disclosed in US Patent Application Publication No. US 2002/0170254 A1. Such single ply roofing systems are known to include an adhesive coating and a rubber membrane. The flexible rubber membrane is formed from, for example, ethylene propylene diene (EPDM), thermal plastic olefin (TPO) or polyvinyl chloride (PVC). The adhesive coating is sprayed directly onto a roofing substrate. The single ply rubber membrane is attached to the roofing substrate by way of the adhesive or mechanical fasteners forming a roofing system.

There are various problems with known roofing systems. For example, built-up roofing systems are applied using molten bitumen and, thus, create a safety hazard for the installers and bystanders. These hazards include fires, explosions, and bums. In addition, built-up roofing systems are known to create significant off-gassing. In addition to the safety hazards, there are performance problems with such built-up roofs. In particular, built-up roofing systems are applied using multiple layers of felt with the bitumen as an adhesive. Due to the nature of the felt in the bitumen, there is little elongation, minimal flexibility, and moderate resistance to impact. In addition, built-up roofing systems are limited in their abilities to be terminated to walls, curbs, penetrations, and edges. Such roofing systems are also limited in their ability to be restored. More particularly, thermal cycling causes the felt to lose its structural integrity. Exposure of the felt to the elements also causes the surfacings and flashings to deteriorate. Unfortunately, once such components deteriorate, they cannot be replaced.

There are also known problems with modified bitumen roofing systems. In particular, such roofing systems are also applied using molten bitumen and thus create safety hazards, such as fires, explosions, and bums. In addition, some modified bitumen systems are mopped in place and, thus, create off-gassing. Other types of modified bitumen roofing systems are also known. However, these systems also have undesirable characteristics. For example, torched in placed, modified bitumen systems are known. Such systems are applied using open flames and, thus, create fire, explosion, and bum hazards for installers and bystanders. Cold process modified bitumen roofing systems are also known. These systems are applied with solvent-based adhesives and release significant solvents into the environment. There are also various physical limitations of such modified bitumen roofing systems. In particular, such modified bitumen roofing systems are applied as pre-manufactured sheets with various internal reinforcing scrims. Due to the nature of the scrims and the bitumen, there is little elongation, moderate flexibility, and moderate resistance to impact. In addition, since such modified bitumen roofing systems are produced in sheets, there are vulnerable lapse in the roofing system. Such modified bitumen roofing systems are also limited in their ability to be terminated to walls, curbs, penetrations and edges and are limited in their ability to be restored. In particular, thermal cycling causes the scrims to lose structural integrity. Exposure to the elements causes the surfacing and flashing to deteriorate, which cannot be restored and must be replaced. Finally, such modified bitumen roofing systems are susceptible to deterioration from water, acids, fuels, oils, and animal fats.

There are also problems associated with the single-ply roofing systems and spray polyurethane foam roofing systems. In particular, as discussed above, such single-ply roofing systems include a single-ply, rubber membrane attached to the roofing system by way of an adhesive. As mentioned above, such adhesives may cause an environmental hazard or mechanical fasteners can rupture the membrane. Spray polyurethane foam roofs are known to be applied directly to the roof substrates and are thus susceptible to movements of the fasteners and the substrates due to thermal cycling.

Each of the above mentioned roofing systems are subject to various problems as discussed above. Thus, there is a need for a roofing system which provides enhanced performance and stability with respect to environmental factors for use in low slope or flat roofing systems without the problems as discussed above.

### SUMMARY OF THE INVENTION

The present invention relates to a multi-layer polyurea roofing system. The roofing system in accordance with the present invention uses spray polyurethane foam as a substrate or base. Even though the polyurethane foam can be used as a waterproofing agent, the main property of the polyurethane foam in the roofing system in accordance with the present invention is to provide a substrate. The polyurethane foam may be applied directly to a roof deck, such as wood, concrete or metal or alternatively it may be applied over traditional type insulation board stock in new construction or replacement applications. In retrofit applications, the roofing systems in accordance with the present invention may be applied directly to an existing roofing system, such as built up roof or modified bitumen roofing system with no insulated board stock. An important aspect of the invention is the use of multilayers of polyurea with the base layer having a minimum thickness of 40 mils, thus forming a waterproofing membrane. The multiple layers of polyurea provide increased structural strength, as well as reduce failures caused by applicator error. Moreover, in applications where the polyurethane foam is applied to insulation board stock, the polyurea membrane is isolated from movements between the base insulation and the roof deck (i.e., wood, metal, concrete decking). In alternate embodiments of the invention, the polyurea membrane may be applied directly over one or more layers of insulation board stock without the polyurethane foam. In retrofit applications, the polyurethane foam may be applied directly over the existing roofing system or alternatively an insulation board may be applied to the existing roofing system and covered with a layer of polyurethane foam. Each of the above mentioned roofing applications provides increased structural integrity and resistance to environmental elements than known roofing systems without the problems mentioned above associated with known roofing systems. Moreover, in applications where the polyurea membrane is applied to an insulation board, the polyurea waterproofing membrane is isolated from movement between the roof deck (i.e., wood, metal or concrete structural deck) and the base insulation. The multilayer of polyurea also provides increased waterproofing and structural strength.

### DESCRIPTION OF THE DRAWING

These and other advantages of the present invention will be readily understood with reference to the following specification and attached drawing wherein:

FIG. 1 is a perspective view of a multilayer polyurea roofing system that utilizes a single layer of insulation board and polyurethane foam in accordance with one embodiment of the present invention.

FIG. 2 is similar to FIG. 1 except that the roofing system in accordance with the present invention is applied to two or more layers of insulation board stock without polyurethane foam.

FIG. 3. is a perspective view of another alternate embodiment of the invention in which multiple layers of polyurea are applied directly to a single layer of insulation board.

FIG. 4 is a perspective of another alternate embodiment of the roofing system in accordance with the present invention in which the roofing system is applied over an existing roof and includes an insulation board, a layer of polyurethane foam and multiple layers of a polyurea.

FIG. 5 is similar to FIG. 4 but illustrates an embodiment in which the polyurethane foam is applied directly to the existing roofing system.

FIG. 6 is a perspective view of the roofing system applied to a metal roof, such as R-panel or standing seam roof.

### DETAILED DESCRIPTION

The present invention relates to a roofing system for low slope or flat roof applications. In accordance with an important aspect of the invention, the roofing system utilizes multiple layers of polyurea as a structural waterproofing membrane. This waterproofing membrane is applied directly on top of an insulation layer, such as a polyurethane spray foam, deposited directly on top of insulation board stock. In alternate embodiments of the invention, the insulation layer is formed from polyurethane spray foam and one or more layers of insulation board stock. In retrofit applications, the polyurea membrane may be applied to an insulation board stock, which, in turn, is applied directly over the existing roofing system. Alternately, the polyurea membrane may be applied to an insulation layer formed from polyurethane spray foam which, in turn, is applied directly to the existing roofing system.

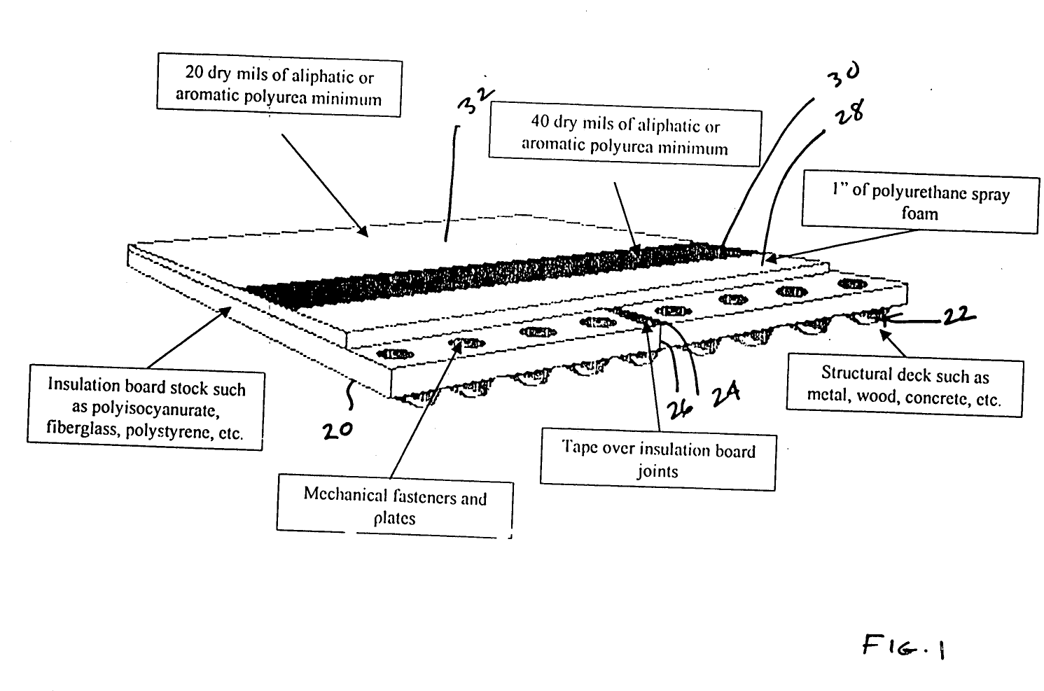

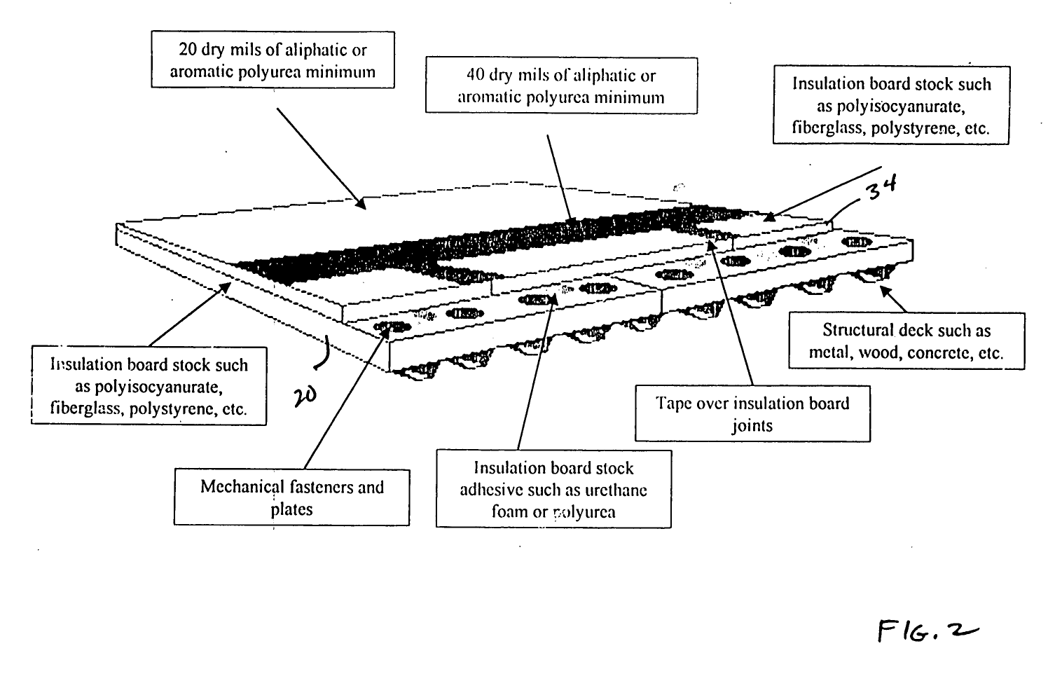

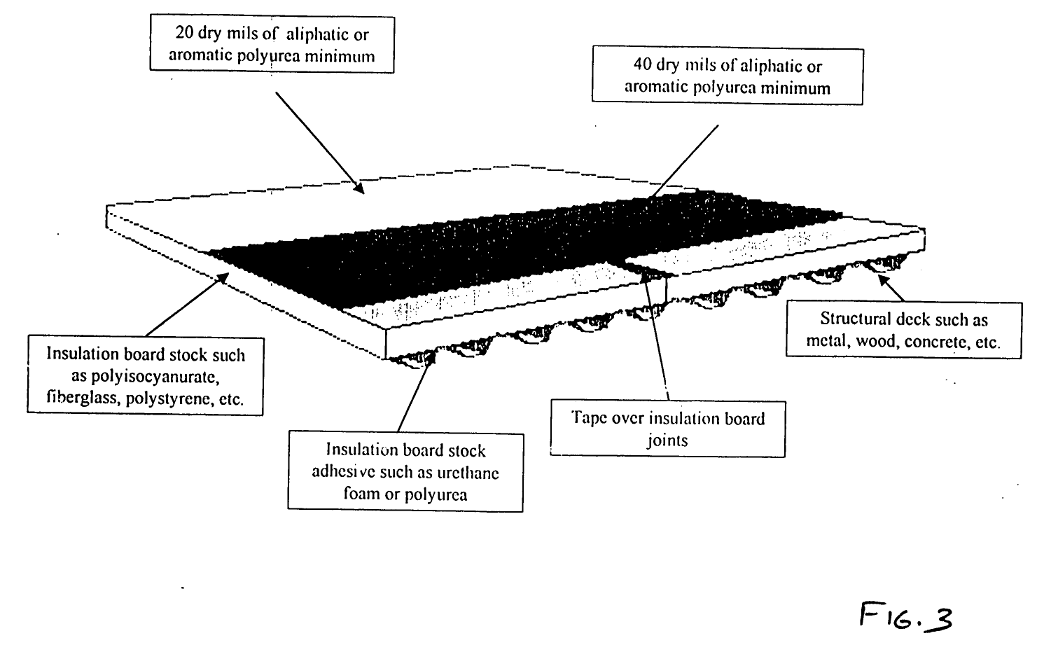

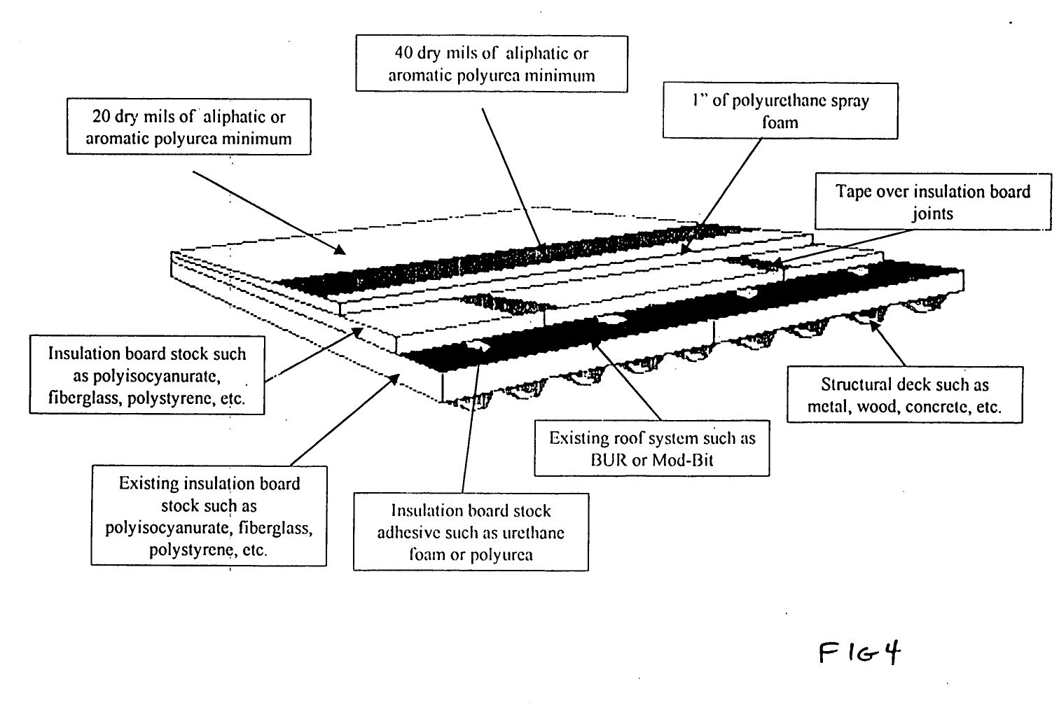

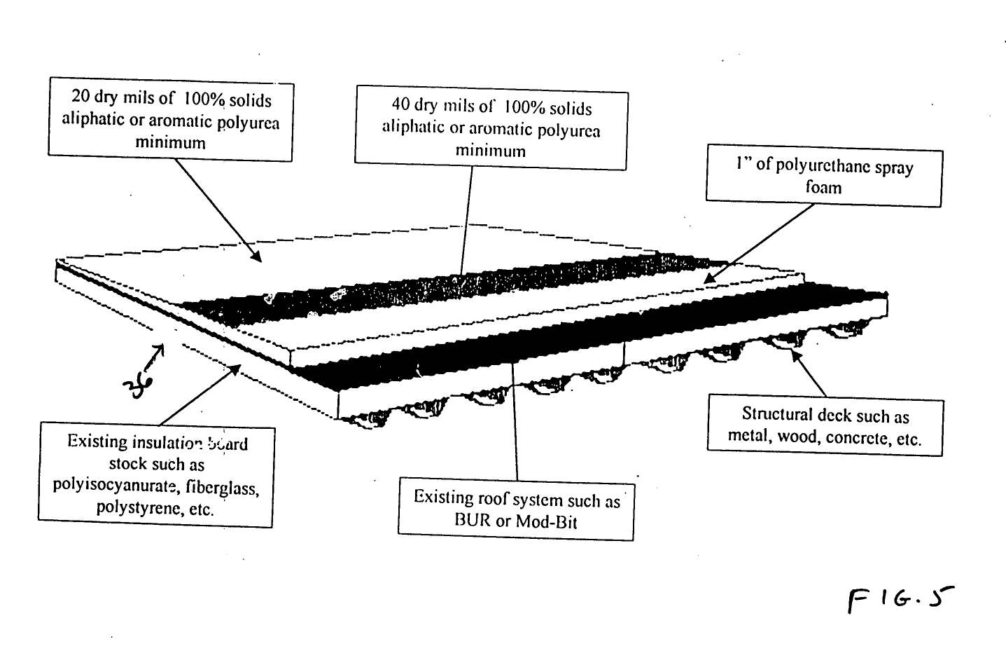

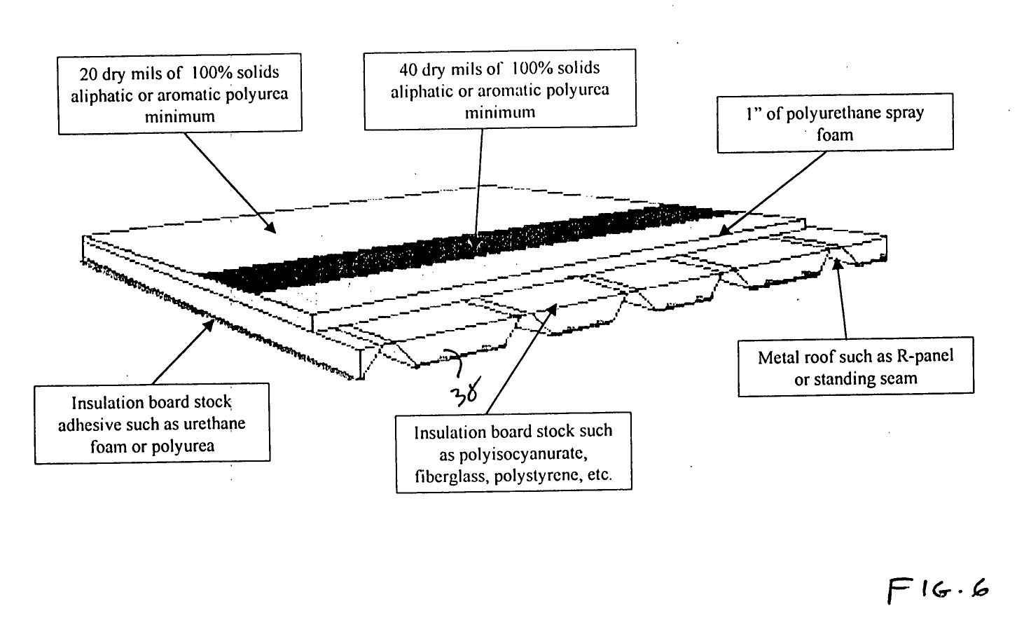

Various embodiments of the invention are disclosed and illustrated. FIGS. 1-3 and 6, relate to new or replacement applications for low slope or flat roof systems formed directly on a roof deck. FIGS. 4 and 5 relate to applications of the roofing system in accordance with the present invention formed over existing roofing systems. More particularly, FIG. 1 illustrates an embodiment of the roofing system in accordance with the present invention utilizing a single layer of insulation board stock. FIG. 2 illustrates an application of the present invention similar to FIG. 1 that utilizes multiple layers of insulation and does not utilize polyurethane foam. FIG. 3 illustrates an embodiment of the present invention in which the insulation layer is formed from one layer of insulation board stock and does not utilize polyurethane foam. FIG. 6 illustrates an application of the roofing system in accordance with the present invention applied to a metal roof, such as the R-panel or standing seam roof.

FIGS. 4 and 5 illustrate an embodiment of the roofing system in accordance with the present invention for use in retrofit applications in which it is installed over existing roofing systems. Specifically, FIG. 4 illustrates an embodiment of the roofing system in accordance with the present invention in which one or more layers of insulation board stock covered by a layer of polyurethane foam spray and multiple layers of polyurea are formed directly on an existing roofing system. FIG. 5 illustrates an embodiment of the roofing system in accordance with the present invention in which the insulation layer is formed from polyurethane foam applied directly to the existing roofing system. Multiple layers of polyurea are applied over the insulation layer forming a structural waterproofing membrane.

As discussed above, all roofing systems include a substrate, thermal insulation and a water proofing membrane. In accordance with an important aspect of the invention, multiple layers of polyurea are used as a structural waterproofing membrane. In order to form a waterproofing membrane, the base layer of the polyurea is at least 40 mils. Amounts less than 40 mils of polyurea are simply coatings. At least one additional top layer of polyurea having a minimum thickness of 20 mils is applied on top of the base layer. This top layer provides additional structural waterproofing adding to the structural integrity of the base layer.

Another important aspect of some embodiments of the invention relates to the use of the insulation board stock as the substrate and for thermal insulation. More particularly, even though spray polyurethane foam is an ideal underlayer for the multiple layers of polyurea, there are certain disadvantages associated with applying the spray polyurethane foam directly to a roof deck. For example, spray polyurethane foam is a water barrier. Although this characteristic protects the building structure from external water intrusion, it can also trap water migrating out of the building. The internal moisture can be caused by water trapped during installation, water intrusion from external leaks and condensation within the building itself. The effects of the internal moisture may cause de-lamination blisters in the spray polyurethane foam from the roof deck and ultimately result in deterioration of the roof deck. By installing the spray polyurethane foam on to an insulation board, these effects can be significantly reduced. In particular, the use of an insulation board stock moves the moisture barrier of the spray polyurethane foam away from the roof deck and thus moves the dew point higher into the assembly. Because of the insulation board stock configuration, vapor transfer is allowed across the entire assembly.

There are other benefits in applying the spray polyurethane foam to the insulation board rather than to the roof deck. In particular, spray polyurethane foam has excellent adhesion characteristics to substrates. Unfortunately, this characteristic makes the system very difficult to remove. Thus, if the roofing system ever needs to be removed for repair, addition of new equipment or additions to the building, the task of removing the roofing system can be relatively difficult and expensive. By applying the spray polyurethane foam to the insulation board stock, the difficulty of the task of removing the insulation system is greatly reduced.

In known roofing systems, the spray polyurethane foam is used for thermal insulation because of its excellent R-value, provided by the closed cell nature of the final product. However, in order to obtain the necessary thickness and thus insulation value, the liquid spray polyurethane foam must be applied in multiple passes. These multiple passes are known to create interlayer de-lamination, irregular surface texture and inconsistent thickness. By installing the insulation board stock as the based layer of thermal insulation in accordance with the present invention, such effects are significantly reduced. A primary R-value is achieved by the insulation board stock and the spray polyurethane foam used as an under layer for the polyurea water proofing membrane. In the present invention, the spray polyurethane foam is applied in a single pass to provide a recovery board effect of one inch or less. The benefits of the present invention can also be realized without the use of spray polyurethane foam as illustrated in FIGS. 2 and 3.

Insulation board stock, such as polyisocyanurate, fiberglass, polystyrene or other known types of insulation board stock may be used for thermal insulation. Such insulation board stock is available under trade names, such as AC Foam II-polyisocyanurate from Atlas Roofing Corp, Meridian, MS. In the embodiments of the invention illustrated in FIGS. 2 and 3, insulation board stock is used as the sole insulation layer. In other embodiments of the invention as illustrated in FIGS. 1 and 4-6, a polyurethane spray is applied on top of the insulation board stock. The polyurethane spray is available under trade names, such as FE 303-3.0HC from Foam Enterprises, Houston, Tex. The polyurethane spray may be sprayed with a spray gun, for example the Fusion Gun by Graco Inc., Minneapolis, Minn. As discussed above, the spray polyurethane foam is applied to a thickness of about one inch. However, other thicknesses may also be used. For example, thicknesses more or less than one inch are suitable for use with the present invention.

In accordance with the present invention, the membrane layer is formed from a base layer of polyurea, which may be aliphatic or aromatic polyurea, having a thickness sufficient to form a membrane, such as 40 mils or more. By applying 40 mils or more, the polyurea layer will form a membrane as opposed to a coating. Additional top layers of polyurea are applied over the base layer. These additional layers provide additional structural integrity, ultraviolet light protection and increased waterproofing ability. The top layer should be at least 20 mils. The polyurea is available under trade names, such as Elasto-Deck 8000, available from Pacific Polymers International Inc. Garden Grove, Calif.

### EXAMPLES

Following are various examples of the multilayer polyurea roofing system in accordance with the present invention.

### Example 1

This example is illustrated in FIG. 1. Initially, in step 1, a single layer of insulation board stock 20 is applied over the roof deck 22. The insulation board stock 20 can be polyisocyanurate, fiberglass, polystyrene or other types of insulation. The insulation boards 20 are attached to a roof deck 22 in a conventional manner using known mechanical fasteners or construction adhesives, such as Insta-Stik polyurethane adhesive by Dow Corning, Midland, Mich. & ASAP 3p fasteners with plates by Olympic, Agawam, Mass. This step normalizes any surface imperfections in the roof deck 22 and provides required wind upload resistance. In step 2, tape 24 may be applied to all insulation board joints 26. Suitable tape for this application is available under trade names, such as Scotch brand masking tape, available from 3M Corp., St. Paul, Minn. The tape 24 normalizes the joints 26 in the insulation board stock 20 and provides a slip-sheet. The slip-sheet action reduces the wear to fatigue effect on the subsequent components.

Next in step 3 up to 1″ or more of spray polyurethane foam, generally identified with the reference numeral 28, is applied on top of the tape 24 and insulation board stock 20. Any density but 3 lb is ideal. The spray polyurethane foam 28 provides a consistent substrate for the polyurea layers. The added benefits provided by the spray polyurethane foam are; a monolithic base, increased insulation, additional waterproofing and dissipation of thermal movement from the substrate.

In step 4, a base layer of polyurea, generally identified with the reference numeral 30, is applied on top of the polyurethane foam 28. The base layer 30 is applied with sufficient thickness to form a membrane, such as 40 mils. Any shore hardness but 80 A is ideal: The application of a minimum of 40 dry mils of polyurea (100% solids is ideal) forms the primary waterproofing membrane. The unique characteristics of polyurea create a structural membrane with excellent elongation, flexibility and tensile strength.

In steps 5, one or more top layers 32 of polyurea are applied on top of the base layer 30. The top layers 32, for example, are formed with a minimum of 20 dry mils of polyurea. Any shore hardness but 80 A is ideal: The application of a minimum of 20 dry mils of polyurea (100% solids is ideal) provides a wear surface and additional waterproofing. The unique characteristics of the polyurea also add to the properties of the base membrane 30 of polyurea. The application of the top layers 32 creates redundancy in the system, which reduces failures caused by applicator error. Mineral surface, such as silica sand, limestone granules, and ceramic granules may be added for additional fire rating and skid resistant walk areas.

In an application over an existing SPF roof system, the existing SPF can be planed to provide as a base layer of insulation eliminating steps 1 and 2. In an embodiment of the roofing system in accordance with the present invention to an existing single ply roof system, the existing single ply membrane can be removed and the existing insulation used as a base layer of thermal insulation, thus eliminating steps 1 and 2.

### Example 2

This example is illustrated in FIG. 2 and is similar to FIG. 1 except that the layer of spray polyurethane foam 28 is replaced with a layer 34 of insulation board stock.

### Example 3

This example is illustrated in FIG. 3 and is similar to FIG. 1 except that the layer of spray polyurethane foam 28 is eliminated. In this embodiment, the base 30 and top 32 layers of polyurea are applied directly on top of the insulation board stock 20 and tape 24.

### Example 4

Example 4 is illustrated in FIG. 4. In this embodiment, the roofing system in accordance with the present invention is applied over an existing roof. In such an application, in step 1, the existing ballast or surface aggregate, such as gravel in a flood and gravel BUR system or loose mineral aggregate in mineral surface Mod-Bit, is removed. The resulting surface may be pressure washed to provide a clean substrate in step 2. Next in step 3, areas of the existing wet roof system and insulation may be removed where needed and replaced with insulation board stock 20 and optionally taped, as discussed above. The insulation boards 20 are attached to the roof deck 22 and existing roof assembly 36 in a conventional manner with mechanical fasteners or construction adhesives in a known manner in step 4. This step normalizes the surface imperfections and provides wind upload resistance. Next in steps 5, 6, and 7, the spray polyurethane foam 28 and base 30 and top 32 layers of polyurea are applied as discussed above.

### Example 5

This example is illustrated in FIG. 5 and is similar to the embodiment illustrated in FIG. 4 except that the roofing system is applied directly over the existing roof assembly 36 without step 4. Depending on the existing roof surface, a primer for the spray polyurethane foam is applied on top of the existing roof assembly 36. A suitable primer is available under trade names, such as ECI Primer 100, available from Everest Coatings, Inc., Houston, Tex. The primer may be applied at a rate, usually 150 to 300 square feet per gallon, required for the substrate to provide proper adhesion of the spray urethane foam.

### Example 6

This example is illustrated in FIG. 6 and is similar to the embodiment described in connection with FIG. 1 except that the roofing system in accordance with the present invention is installed over a metal roof deck 38. However, in this embodiment, the insulation board stock 20 is cut and set between the raised metal ribs. The insulation board thickness is selected to be flush with the tops of the exposed metal ribs. The exposed tops of the metal ribs provide increased upload resistance due to the adhesion of the polyurethane foam.

Obviously, many modifications and variations of the present invention are possible in light of the above teachings. Thus, it is to be understood that within the scope of the appended claims, the invention may be practiced otherwise than is specifically described above.

What is claimed and desired to be secured by a Letters Patent of the United States is:

1. A roofing system comprising:
a substrate;
thermal insulation; and
a structural waterproofing membrane, wherein said structural waterproofing membrane is formed from two or more layers of polyurea.

2. The roofing system as recited in claim 1, wherein one or more layers of insulation board stock are used for said thermal insulation.

3. The roofing system as recited in claim 2, further including means for fastening said one or more layers of said insulation board stock to a roof deck.

4. The roofing system as recited in claim 3, wherein said fastening means includes an adhesive.

5. The roofing system as rented in claim 3, wherein said fastening means includes a plurality of mechanical fasteners.

6. The roofing system as recited in claim 3, further including tape for taping joints defined by adjacent insulation boards.

7. The roofing system as recited in claim 3, further including a layer of spray polyurethane foam over said one or more layers of insulation board.

8. A roofing system as recited in claim 1, wherein said two or more layers of polyurea are formed on top of said one or more layers of insulation board stock.

9. The roofing system as recited in claim 1, wherein said one or more layers of insulation board stock are disposed on top of roof deck which acts as said substrate.

10. The roofing system as rented in claim 2, wherein said one or more layers of insulation board stock are disposed on top of an existing roofing system.

11. The roofing system as recited in claim 10, further including a layer of polyurethane foam over said one or more layers of insulation board stock.

12. The roofing system as recited in claim 1, wherein said layer of polyurethane foam is applied directly over an existing roofing system, said existing roofing system acting as said substrate and said thermal insulation.

13. The roofing system as recited in claim 1, wherein said insulation board stock is cut to fit between upstanding ribs of a metal roof deck.

14. A process for roofing, the process comprising the steps of:
(a) disposing one or more layers of insulation board stock on a substrate;
(b) spraying a base layer of polyurea on top of said one or more layers of insulation board stock of sufficient thickness to form a membrane; and,
(c) forming one or more top layers of polyurea on top of said base layer.

15. The process as recited in claim 14, further including the step of:
spraying a layer of polyurethane foam on top of said one or more layers of insulation board stock; and wherein said base layer of said polyurea is applied over said layer of polyurethane.

16. The process as recited in claim 14, wherein step (a) comprises:
(a) disposing one or more layers of insulation board stock on a roof deck.

17. The process as recited in claim 14, wherein step (a) comprises:
(a) disposing one or more layers of insulation board stock on an existing roofing system.

18. The process as recited in claim 14, wherein step (a) comprises:
(a) disposing one or more layers of insulation board stock on a metal roof, having upstanding ribs such that said one or more layers of insulation board fit between said upstanding metal ribs.

19. A process for roofing, the process comprising:
(a) depositing a layer of polyurethane foam on top of a substrate; and
(b) depositing a base layer of polyurea on top of said layer of polyurethane foam, said base layer of polyurea having sufficient thickness to form a membrane.

20. The process as recited in claim 19, further including the step of depositing one or more top layers of polyurea on top of said base layer.
